(19) United States
(12) Patent Application Publication
(10) Pub. No.: US 2016/0062705 A1
(43) Pub. Date: Mar. 3, 2016

(54) IMAGE FORMING APPARATUS, CONTROL METHOD OF IMAGE FORMING APPARATUS, AND STORAGE MEDIUM

(71) Applicant: CANON KABUSHIKI KAISHA, Tokyo (JP)

(72) Inventor: Ritsuko Otake, Tokyo (JP)

(21) Appl. No.: 14/813,878

(22) Filed: Jul. 30, 2015

(30) Foreign Application Priority Data
Aug. 28, 2014 (JP) 2014-173737

(51) Int. Cl. G06F 3/12

(52) U.S. Cl. CPC G06F 3/1201

(57) ABSTRACT

In the case where printing is performed while reducing the amount of color material to be used, the visual recognizability of objects is maintained while maintaining the quality of a specific object common to a plurality of pages. An image forming apparatus having a color material saving mode to save the amount of color material to be used at the time of printing input image data includes a user interface for a user to perform an input operation, and the user interface includes a unit configured to register an image of a specific object used in the input image data and a unit configured to specify an image processing method for reducing the amount of color material to be used, which is applied to the registered image of the specific object at the time of printing the input data in the color material saving mode.

### BACKGROUND OF THE INVENTION

1. Field of the Invention

The present invention relates to a technique to reduce the amount of color material to be used at the time of printing.

2. Description of the Related Art

In circumstances in which a large number of printing apparatuses and applications having a function to save the amount of color material to be used at the time of printing have been put to practical use, various techniques to securely reduce the amount of color material while keeping the image quality of printed matter as high as possible and the amount of information as much as possible have been proposed. For example, there is a technique to prohibit image conversion processing from being performed on an object that should not be modified, such as a company logo, and to perform conversion control for other objects by taking into consideration the difference between the upper limit value of the amount of color material to be used and the amount of color material that is used because image conversion processing is prohibited at the time of carrying out image conversion in order to reduce the amount of color material to be used (see Japanese Patent Laid-Open No. 2013-186319).

Further, a technique has been proposed that switches image processing for each object so that the amount of toner to be consumed is equal to or less than a specified amount for each page (see Japanese Patent Laid-Open No. 2013-117715).

For example, with the technique of Japanese Patent Laid-Open No. 2013-186319, in the case where there exists an object for which image conversion processing is prohibited, there is a possibility that visual recognizability will be degraded considerably because the level of conversion for other objects becomes high in order to keep the amount of color material to be used at the time of printing within the upper limit value.

Further, with the technique of Japanese Patent Laid-Open No. 2013-117715, in the case where there exists an object common to all the pages, such a problem that the appearance of the object is different for different pages will arise.

### SUMMARY OF THE INVENTION

An image forming apparatus according to the present invention is an image forming apparatus having a color material saving mode to save the amount of color material to be used at the time of printing input image data, and includes a user interface for a user to perform an input operation, and the user interface has a unit configured to register an image of a specific object that is used in the input image data and a unit configured to specify a method of image processing for reducing the amount of color material to be used, which is applied to the registered image of the specific object at the time of printing the input data in the color material saving mode.

Further features of the present invention will become apparent from the following description of exemplary embodiments (with reference to the attached drawings).

### BRIEF DESCRIPTION OF THE DRAWINGS

FIG. 1 is a diagram showing an example of a configuration of a printing system;

FIG. 2 is a block diagram showing an internal configuration of an image forming apparatus;

FIG. 3 is a block diagram showing an internal configuration of an RIP unit;

FIGS. 4A and 4B are diagrams showing examples of a setting screen in relation to toner saving processing in a printer driver;

FIG. 5 is a diagram showing an example of a setting screen for setting details of a stamp or logo on which toner saving special processing is to be performed;

FIG. 6 is a diagram showing a relationship between FIGS. 6A and 6B;

FIGS. 6A and 6B are flowcharts showing a flow until toner saving processing is performed on each object within input image data;

FIG. 7 is a diagram showing an example of the total amount of toner to be used for each page;

FIG. 8 is a graph representing a relationship between the total amount of toner to be used for each page and the area ratio of the object; and

FIG. 9 is a diagram showing an example of a setting screen for specifying limitations on the toner saving processing for a specific object.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

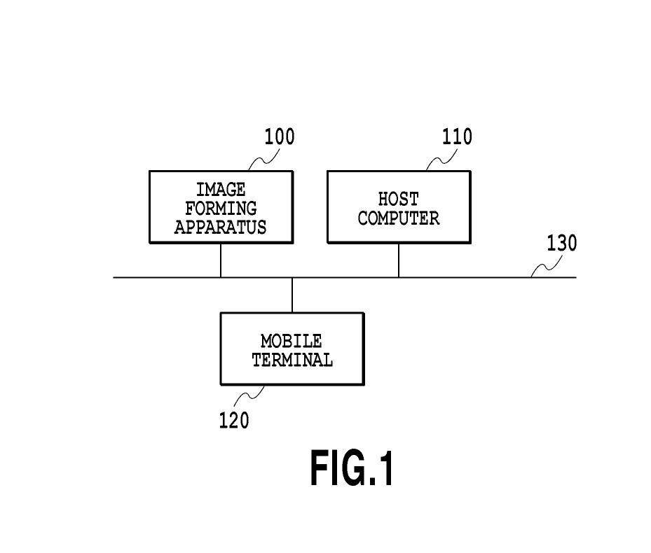

FIG. 1 is a diagram showing an example of a configuration of a printing system suitable to application of the present embodiment. The printing system in FIG. 1 includes an image forming apparatus 100, a host computer 110, and a mobile terminal 120 and each unit is connected to one another via a network 130, such as a LAN.

The image forming apparatus 100 is a printing apparatus having a function to save the amount of color material to be used at the time of printing, and forms and outputs an image on a printing medium, such as paper, based on input image data. Further, the image forming apparatus 100 has a copy function to read a document with an image reading device (scanner), not shown, and to print and output the generated image data.

The host computer 110 and the mobile terminal 120 transmit image data of a document or the like generated by an application to the image forming apparatus 100 via the network 130 and give instructions to perform printing. Further, it may also be possible to receive image data (scanned data) obtained by scanning a document from the image forming apparatus 100 and to obtain image data for printing by editing etc. the received scanned data.

In the present embodiment, explanation is given on the assumption that the image forming apparatus 100 performs printing and outputting upon receipt of instructions to perform printing from the host computer 110 and the mobile terminal 120, but it is also possible to apply the present embodiment in the case where the above-described copy function is in operation.

Next, details of the image forming apparatus 100 are explained.

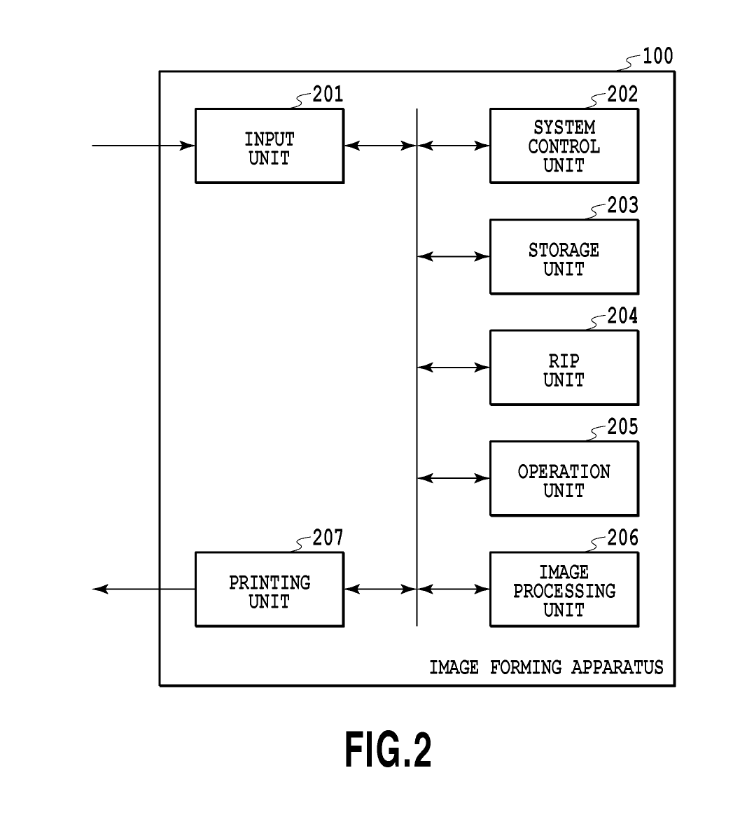

FIG. 2 is a block diagram showing an internal configuration of the image forming apparatus 100. The image forming apparatus 100 includes an input unit 201, a system control unit 202, a storage unit 203, an RIP unit 204, an operation unit 205, an image processing unit 206, and a printing unit 207.

The input unit 201 receives image data to be printed, which is transmitted from an external device, such as the host computer 110 and the mobile terminal 120. Further, the input unit 201 receives scanned data from the scanner.

The system control unit 202 is a controller that controls the whole of the image forming apparatus 100 and includes a CPU, which is an operation processing unit, a RAM as a work memory, a ROM that stores boot programs or the like, etc.

The storage unit 203 is, for example, a storage device having a large capacity, such as an HDD, and in which image data that is input to the input unit 201 and information attached to the image data are stored.

The RIP unit 204 performs object analysis processing and color material saving processing after converting input image data into image data (bitmap data) to be used for printing and outputting where necessary. Details of the processing in the RIP unit 204 will be described later.

The operation unit 205 is a user interface (UI) for a user to perform various operations and includes a liquid crystal screen, a touch panel, operation buttons, etc. Information input to the operation unit 205 is sent to the system control unit 202.

The image processing unit 206 performs predetermined image processing for printing processing, for example, gamma correction processing, quantization processing, etc., on bitmap data received from the RIP unit 204.

The printing unit 207 forms and outputs an image on a printing medium in accordance with the image data (bitmap data) for printing and outputting on which predetermined image processing has been performed by the image processing unit 206. In the present embodiment, explanation is given by taking the electrophotographic scheme that utilizes toner as a color material as an example, but the printing scheme is not limited and, for example, the ink jet scheme that utilizes ink as a color material may be accepted.

Subsequently, the RIP unit 204 is explained in more detail.

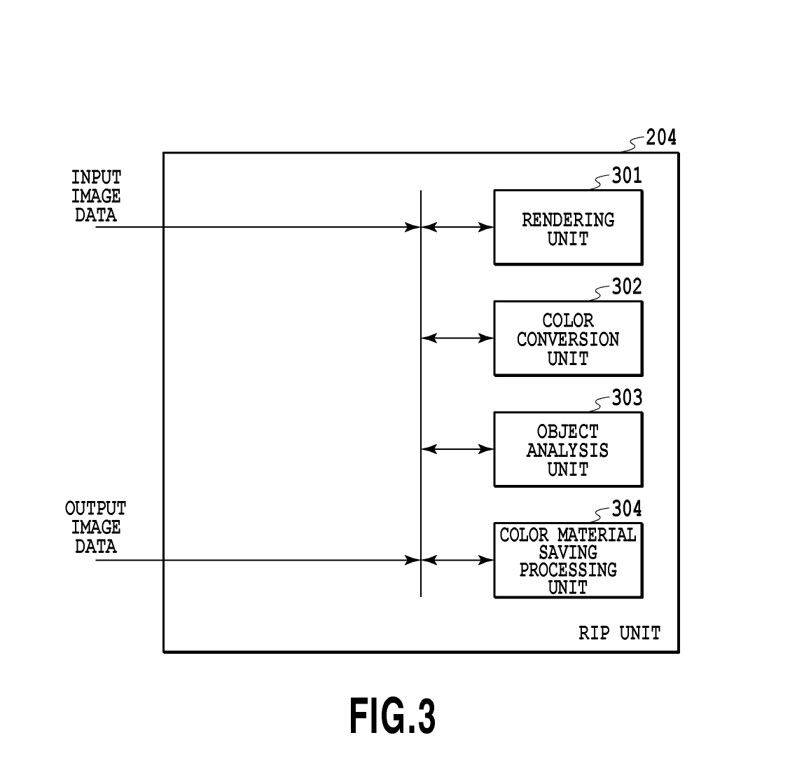

FIG. 3 is a block diagram showing an internal configuration of the RIP unit 204. The RIP unit 204 includes a rendering unit 301, a color conversion unit 302, an object analysis unit 303, and a color material saving processing unit 304.

The image data that is input to the RIP unit 204 is sent to the rendering unit 301 in the case where the input image data is data in the page description language format (PDL data). In the case where the input image data is scanned data, the image data is already in the bitmap form, and therefore, is sent to the object analysis unit 303 without being sent to the rendering unit 301.

The rendering unit 301 interprets the PDL command included in the PDL data and develops the input image data into image data in the bitmap format.

The color conversion unit 302 performs processing to convert the color space of the bitmap data from RGB at the time of being input into the color space (here, CMYK) compatible with the printing unit 207. The bitmap data converted into CMYK is sent to the image processing unit 206 and predetermined image processing for printing processing is performed. In this manner, the CMYK bitmap data that the printing unit 207 can utilize is generated.

The object analysis unit 303 performs processing to determine a representative object kind by identifying the attributes of objects within the input image data by performing image area separation processing or the like where necessary. Here, the attributes of objects refer to the kinds of object, such as text, graphics, and image. Then, the representative object kind refers to an object kind whose proportion is the greatest among the objects included in a predetermined page to be analyzed. Details of the object analysis processing will be described later. It may also be possible to perform the object analysis before color conversion that is carried out by the color conversion unit 302.

The color material saving processing unit 304 performs image conversion processing (hereinafter, color material saving processing) to reduce the amount of color material to be used on each object within the input image data. For example, the color material saving processing includes methods, such as density decrease processing, monochromatization processing, edge preservation processing, and thinning processing (processing to reduce the width of a line). The density decrease processing is processing to decrease the output density by increasing the luminance value of the image data. The monochromatization processing is processing to convert a color image into a monochrome image, and for example, color image data consisting of four colors of CMYK is converted into image data represented in gray (K alone). The edge preservation processing is processing to preserve only edge areas and to decrease the density of areas other than the edge areas, and pixels other than those in which a difference from the original signal value equal to or greater than a fixed value occurs are converted into a signal of white or a signal in which the density is decreased by performing edge enhancement processing or blurring filter processing on the image. The thinning processing is processing to reduce the width of a line and the pixel value of the pixel in the boundary area of the line on which processing is to be performed, such as a character, is replaced with the pixel value of the adjacent pixel in an area other than the boundary area. It is also possible to switch the method of the color material saving processing to another in accordance with attribute information, to be described later, which is given for each pixel. It is sufficient to specifically determine which processing method to apply as color material saving processing by holding processing methods determined by taking the attributes of the objects into consideration in the RAM or the like in a table format, for example, as Table 1 below.

TABLE 1

| | TONER SAVING | PROCESSING |
|---|---|---|
| OBJECT | PROCESSING | CONDITION |
| KIND | METHOD | (INITIAL VALUE) |
| TEXT | THINNING | THINNING |
| | PROCESSING | RATIO: 20% |
| GRAPHICS | EDGE PRESERVATION | PRESERVED EDGE |
| | PROCESSING | WIDTH: 7 PIXELS |
| | | (600 DPI) |
| IMAGE | DENSITY DECREASE | DENSITY DECREASE |
| | PROCESSING | RATIO: 30% |

In Table 1 described above, the attribute of an object is associated with the method of toner saving processing and the initial value in each method is described.

Next, the control of color material saving processing that characterizes the present embodiment is explained in detail. As the control rule of the color material saving processing, there can be various rules, such as for each page, for each job, for each user, and for each assigned division, and any rule can be applied, but in the following, the case where control is performed for each page (the upper limit value of the amount of toner that can be used for each page is specified) is explained as an example. The present embodiment premises the electrophotographic scheme that utilizes toner as a color material, and therefore, in the following, the color material saving processing is referred to as “toner saving processing”.

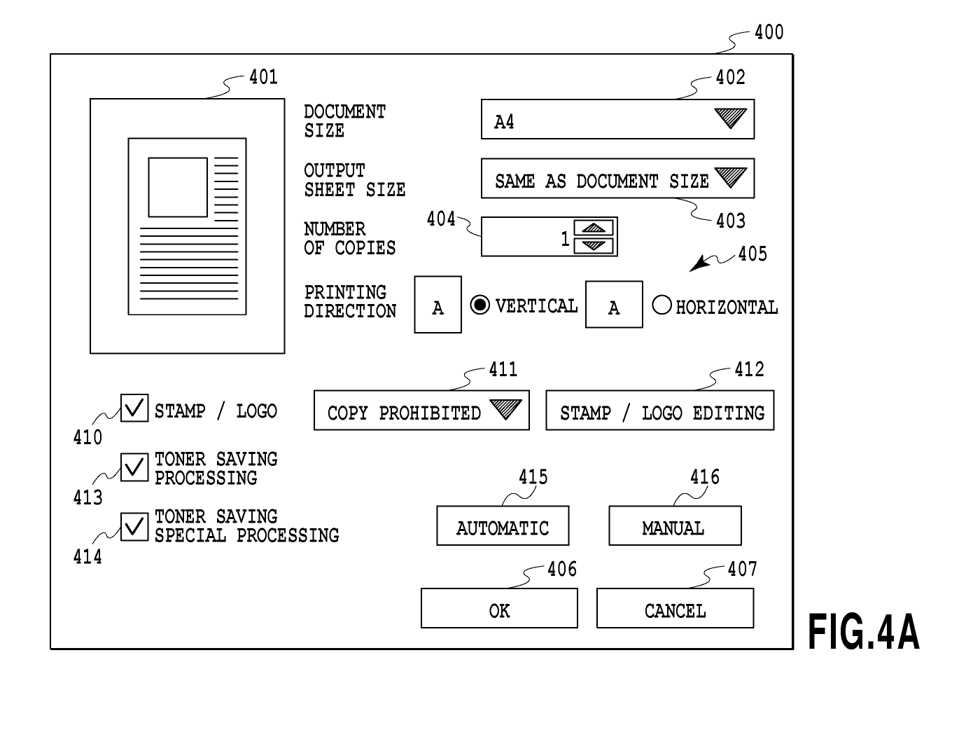

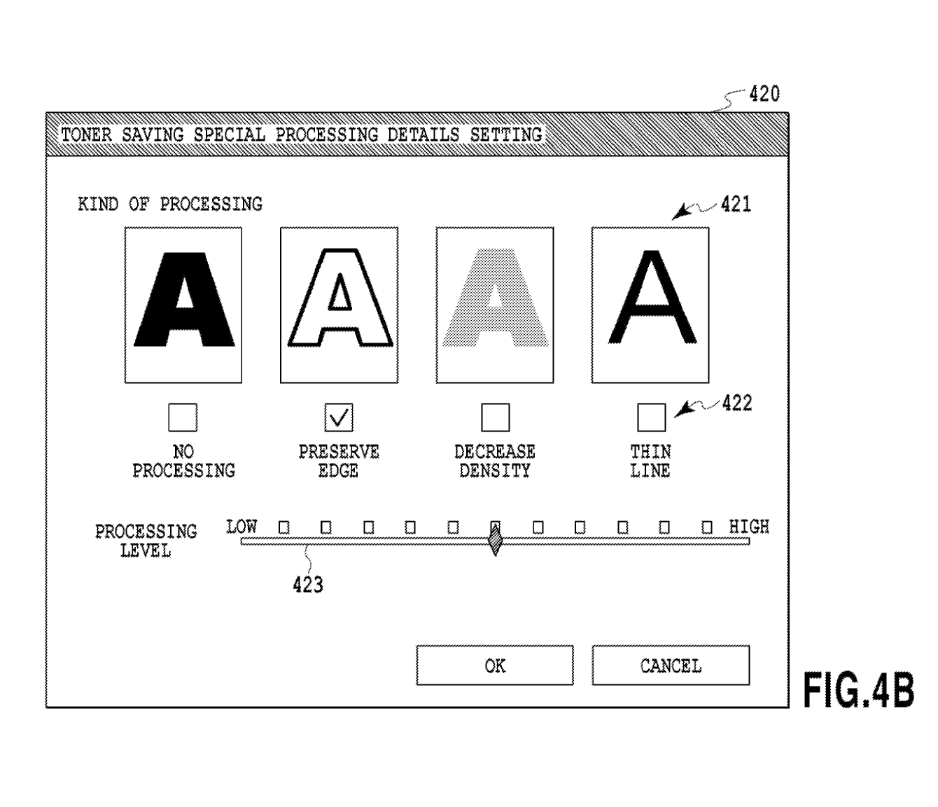

FIG. 4A and FIG. 4B are diagrams showing examples of a setting screen in relation to the toner saving processing in a printer driver, which is used in the case where instructions to perform printing are given from the host computer 110. The setting screen as shown in FIG. 4A and FIG. 4B may be displayed on the operation unit of the host computer 110, or on the liquid crystal screen of the operation unit 205 of the image forming apparatus.

FIG. 4A shows a main screen 400 of a setting screen in relation to the toner saving processing. On the main screen 400, a preview area 401, a Document size setting area 402, an Output sheet size setting area 403, a Number of copies setting area 404, a Printing direction setting area 405, etc., are included, which are used for a normal printing setting. Further, an OK button 406 to settle the setting, a Cancel button 407 to cancel the setting, etc., common to other screens are also included.

On the main screen 400, a stamp addition checkbox (checkbox for addition of stamp/logo) 410, a stamp selection area 411, and a stamp editing button 412 are used to set a stamp or logo to be attached at the time of printing. In the case where the stamp attachment checkbox 410 is marked, the setting is such that a specified stamp or logo is attached to printed matter. In the stamp selection area 411, alternatives, such as “Confidential” indicating a confidential document, a company logo registered in advance, other symbol marks, etc., are displayed, in addition to a stamp indicating the prohibition of copy, and a desired stamp or the like is selected therefrom. A Toner saving processing checkbox 413 is used to perform printing after performing the toner saving processing on an object within an image to be printed and in the case where the Toner saving processing checkbox 413 is marked, the toner saving processing is available. A Toner saving special processing checkbox 414 is used in the case where it is desired to separately set the contents of the toner saving processing for an object, such as a selected stamp. For example, in the case where a company logo is selected in the stamp selection area 411, it is possible to perform a setting so that the toner saving processing is not at all performed on the company logo, or to set a toner saving processing method different from that for other objects, and in the case where the checkbox is marked, the toner saving special processing is available. In the case where neither the stamp attachment checkbox 410 nor the Toner saving processing checkbox 413 is marked, marking the Toner saving special processing checkbox 414 is ignored. An Automatic button 415 is a button for specifying automatic toner saving special processing and a Manual button 416 is a button for specifying a manual setting of details of the toner saving special processing, and in the case where the Toner saving special processing checkbox 414 is marked, it is possible to select one of the buttons. Then, in the case where the Manual button 416 is pressed down, a Toner saving special processing details setting screen 420 as shown in FIG. 4B is displayed.

On the Toner saving special processing details setting screen 420, processing image areas 421 each showing the kind of toner saving processing by a processing image (sample image) that can be grasped intuitively, checkboxes 422 for making each toner saving processing method available/unavailable, and a Processing level setting area 423 for specifying the level (intensity) of the toner saving processing are included. The sample image within the processing image area 421 may be changed in accordance with the state of toner saving processing method selection, to be selected later, and the state of the processing level setting. The checkbox 422 is provided for each toner saving processing method that can be selected and it is also possible to mark a plurality of checkboxes 422 at the same time. However, in the case where “No processing” is marked, the checkmarks in the other checkboxes are all canceled. The Processing level setting area 423 is provided with an adjustment bar for adjusting the level of the effect of reducing the amount of toner to be used by each piece of the toner saving processing and the level at which or degree in which each piece of the toner saving processing is applied is determined in accordance with the position where the pointer is located. It may also be possible to design a configuration in which a plurality of adjustment bars each corresponding to each toner saving processing method in a one-to-one manner is displayed and adjustment can be made for each toner saving processing method.

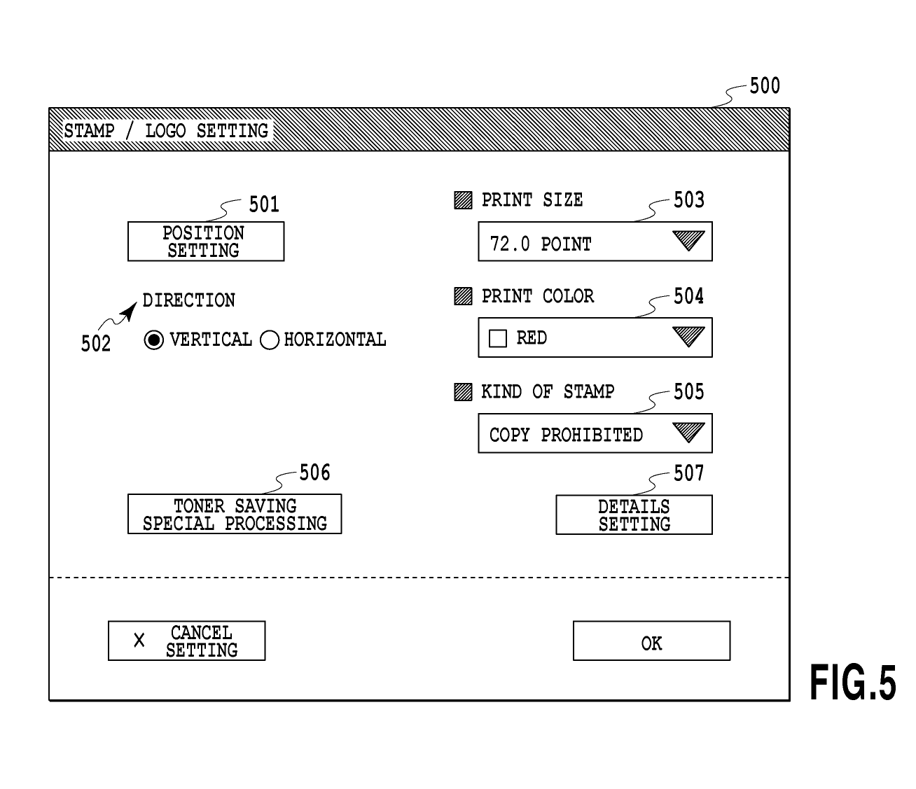

FIG. 5 is a diagram showing an example of a setting screen for setting details of a stamp or logo on which the toner saving special processing is to be performed. On a Stamp/logo setting screen 500, a button 501 for setting a position of a stamp or the like on a page, an area 502 for setting a direction, such as a vertical direction and a horizontal direction, an area 503 for setting a print size, an area 504 for setting a print color, etc., exist. Then, an area 505 is an area corresponding to the above-described stamp selection area 411 and it is possible to select a desired stamp or the like from among displayed alternatives. A Toner saving special processing button 506 corresponds to the above-described Toner saving special processing checkbox 414 and in the case where the Toner saving special processing button 506 is pressed down, the same state as that where the above-described Toner saving special processing checkbox 414 is marked is brought about. A details setting of the toner saving special processing in this case is performed on another screen (not shown) corresponding to that in FIG. 4B described previously, which is displayed in the case where the Toner saving special processing button 506 is pressed down. A Details setting button 507 is used to set other details.

In the present embodiment, the specific object to which the toner saving special processing is applied is a stamp or company logo, but the specific object is not limited to those and it is possible to arbitrarily set, for example, a special logo or symbol mark whose modification is not permitted as a specific object. Further, for convenience of explanation, it is assumed that the specific object is common to all the pages of a document or the like to be printed, but the specific object may be an object that is attached to only part of pages.

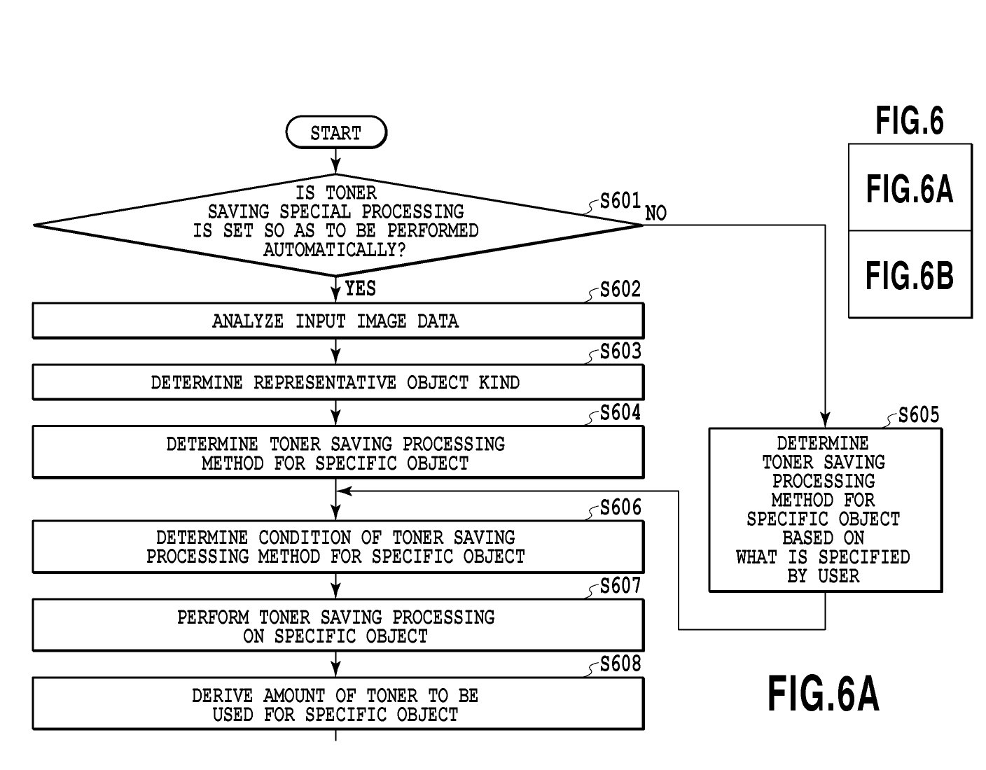

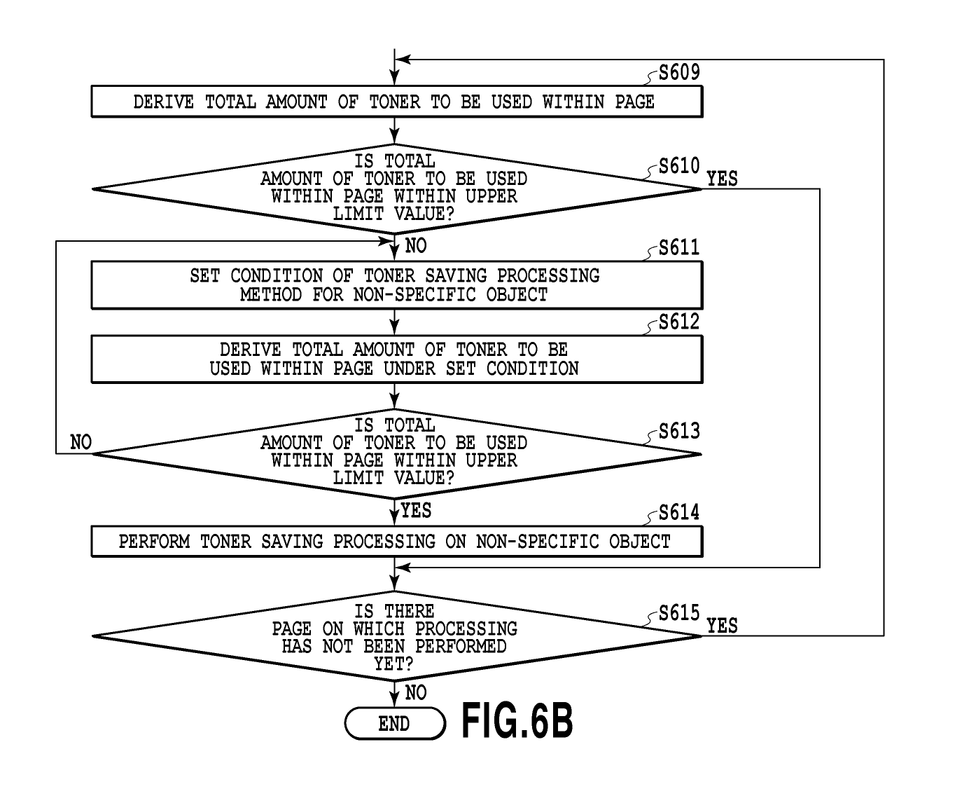

Subsequently, how the toner saving processing is performed on each object in the case where the toner saving special processing is specified by a user is explained in detail. FIGS. 6A and 6B are flowcharts showing a flow until the toner saving processing is performed on each object within input image data in the case where the toner saving special processing is set. The series of processing is performed by the CPU within the system control unit 202 executing programs stored in the ROM after loading the programs onto the RAM.

At step 601, the system control unit 202 determines whether the automatic or manual toner saving special processing is set. In the case where the automatic toner saving special processing is set (in the case where the Automatic button 415 is pressed down on the main screen 400 described previously), the processing proceeds to step 602. Due to this, object analysis processing is performed. On the other hand, in the case where the manual toner saving special processing is set (in the case where the Manual button 416 is pressed down on the main screen 400 described previously), the processing proceeds to step 605.

At step 602, the object analysis unit 303 receives instructions from the system control unit 202, analyzes the input image data (bitmap data) of a document or the like to be printed, and specifies the attributes of the objects included in each page. Specifically, in the case where the original input image data is scanned data, image area separation processing is performed on all the pages and the attributes of the objects included within each page are identified. In the case where the original input image data is PDL data, the information on the PDL command of each page is acquired in advance and the attributes of the objects included in each page are identified from the acquired information.

At step 603, the object analysis unit 303 performs processing to determine the representative object kind that serves as basic information for determining the toner saving processing method for the specific object on a predetermined page (hereinafter, a basic page) within the input image data. First, the basic page is determined based, for example, on the object configuration of each page. Explanation is given by taking a specific example.

Here, it is assumed that image data of a document consisting of three pages is input and the object configuration within each page is as follows. Here, “%” represents a proportion (area ratio) occupied by each object within each page.

1. Page 1 (Text: 10%, Graphics: 30%, Image: 0%)

2. Page 2 (Text: 10%, Graphics: 40%, Image: 0%)

3. Page 3 (Text: 0%, Graphics: 0%, Image: 60%)

In the page 1 and page 2, the configuration is such that the proportion of graphics is the highest and the proportion of text is the second highest. Then, the page 3 consists of only images (proportion of image is the highest), and the proportion of text and the proportion of graphic are the same (0%). In the case of this document data, the number of pages with the object configuration in which the proportion of graphics is the highest and the proportion of text is the second highest is large, and therefore, an arbitrary page (e.g., a page closest to the first page) is determined to be the basic page from among the pages having the configuration. In the example described above, the page 1 is determined to be the basic page. Alternatively, it may also be possible to determine a page a user directly specifies on an operation screen, not shown, to be the basic page, or to determine the first page or all the pages of the document data to be the basic page or basic pages. After the basic page is determined, the object analysis unit 303 derives the area ratio of each object kind to the whole of the basic page. Then, based on the derived area ratio, the object analysis unit 303 determines the representative object kind. Specifically, values T′, G′, and I′ obtained by multiplying the proportion occupied by each object kind in the basic page by a predetermined weight coefficient are found and the object kind corresponding to the maximum value of T′, G′, and I′ is determined to be the representative object kind. Here, T′ corresponds to text, G′ corresponds to graphics, and I′ corresponds to images. Then, as the weight coefficient, a numerical value is set in advance, for example, “6” is set for text, “3” is set to graphics, and “1” is set to images. In the specific example described above, in the case where the page 1 is taken to be the basic page, T′ is 6×10%=0.6, G′ is 3×30%=0.9, and I′ is 1×0%=0, and the maximum value is 0.9, and therefore, the representative object kind is determined to be graphics. Further, the object analysis unit 303 generates information (characteristics information) indicating characteristics of each page, such as the size, the number of tone levels, the average value of density values, the variance value, the proportion of edge area, etc., of the object. Then, the information on the determined representative object kind and the generated characteristics information are sent to the system control unit 202.

At step 604, the system control unit 202 determines the toner saving processing method for the specific object by referring to a toner saving special processing determination table as Table 2 shown below based on the representative object kind determined at step 603.

TABLE 2

| | SPECIFIC OBJECT |
|---|---|
| REPRESENTATIVE | TONER SAVING |
| OBJECT KIND | PROCESSING METHOD |
| TEXT | THINNING |
| | PROCESSING |
| GRAPHICS | EDGE PRESERVATION |
| | PROCESSING |
| IMAGE | DENSITY DECREASE |
| | PROCESSING |

In the toner saving special processing determination table of Table 1, the representative object kind and the toner saving processing method are associated with each other in a one-to-one manner, and for example, in the case where the representative object kind is text, the thinning processing is determined to be the toner saving processing method for the specific object. In this case, it may also be possible to prepare the table such as Table 2 for each kind of stamp or logo as a specific object and to select and use the table in accordance with the specified specific object.

At step 605, the system control unit 202 determines the toner saving processing method specified by a user on the above-described Toner saving special processing details setting screen 420 to be the toner saving processing method for the specific object.

At step 606, the system control unit 202 determines the condition in the case where the toner saving processing is applied to the specific object by the method (processing method) determined at step 604 or step 605 by referring to the above-described characteristics information, what is specified by a user, etc. For each toner saving processing method, the initial value of the condition is set in advance. In Table 1 described previously, Thinning ratio=20% means that the thickness of the line is reduced by 20% from the original thickness (the thickness is reduced to 80% of the original thickness). Preserved edge width specifies the width of the line that should be preserved as an edge and the case of Table 1 indicates that a width corresponding to seven pixels at 600 dpi is preserved as an edge. Density decrease ratio=30% means that the density is decreased by 30% from the original density (the density is decreased to 70% of the original density).

In the case where, for example, the density decrease processing is applied as the toner saving processing method, the density of the whole of the image object that occupies a great proportion within a page is converted into a low density uniformly, and therefore, as the initial value, a density decrease ratio suitable to the image object is prepared. At this step, the condition that is applied finally is determined by appropriately changing the initial value in accordance with the relationship between the attribute of the specific object (object kind) and the representative object kind, the size of the specific object, etc. For example, in the case where the attribute of the specific object is text, a table is prepared in advance in which the font kind/size and the recommended preserved edge width are associated with each other. Then, the preserved edge width to be applied is changed from the initial value (e.g., 7 pixels into 2 pixels) in accordance with the contents (e.g., text in Gothic type and in 14 point size or the like) of the specific object on which the processing is to be performed. In addition to this, in the case where the toner saving processing method is determined to be the density decrease processing and on a condition that the attribute of the specific object is an image, it may also be possible to apply the initial value as it is, and on a condition that the attribute is text, it may also be possible to set the density decrease ratio to a value smaller than the initial value. Due to this, the legibility of a character, which is the specific object, is guaranteed. Further, in the case where the attribute of the specific object is an image and the toner saving processing method is determined to be the density decrease processing and on a condition that the size is extremely small or on a condition that the original density is extremely low, it may also be possible to set the density decrease ratio to a value smaller than the initial value in order to avoid disappearance of the specific object. In this case, it is sufficient to hold the lower limit value of the size or density as a threshold value in advance and to perform determination by making a comparison using this.

At step 607, the color material saving processing unit 304 receives instructions from the system control unit 202 and performs the toner saving processing (thinning, edge preservation, density decrease, etc.) on the specific object in accordance with the determined toner saving processing method and the condition.

At step 608, the system control unit 202 derives the amount of toner to be used (here, four colors of CMYK) necessary to draw the specific object from the results of the toner saving processing for the specific object performed at step 607. It is possible to derive the amount of toner to be used by using, for example, a model-dependent conversion expression. Specifically, by multiplying the CMYK signal value by γ, normalization is performed with the amount of toner (milligram) corresponding to the maximum density. Here, explanation is given on the assumption that 5 milligrams are derived.

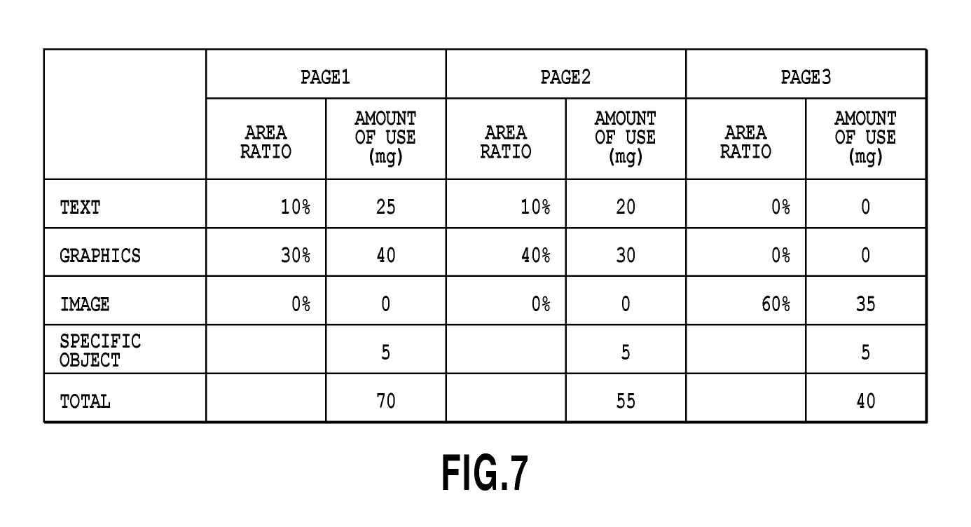

At step 609, the system control unit 202 derives the amount of toner to be used necessary to draw all the objects included in the input image data for each page. Derivation may be performed for any page and it is sufficient to perform derivation from, for example, the first page in order. In the case of the present embodiment in which the specific object is an object common to all the pages, as the amount of toner to be used for the specific object, the value derived at step 608 is used for every page. Consequently, at this step, first, the amount of toner to be used is derived for an object other than the specific object (hereinafter, a non-specific object) by using the above-described conversion expression for each object kind. Then, the derived amount of toner to be used for each non-specific object kind is summed and the sum value and the value derived at step 608 are further summed and thus the total amount of toner to be used is derived for each page. FIG. 7 shows the total amount of toner to be used for each page derived for document data consisting of three pages in total, which is shown in the specific example described above. In this example, the amount of toner to be used is 70 mg for the page 1, 55 mg for the page 2, and 40 mg for the page 3 and it is known that each page includes 5 mg for the specific object.

At step 610, the system control unit 202 determines whether or not the total amount of toner to be used corresponding to one page derived at step 609 is within the predetermined upper limit value. The upper limit value is set in advance and is held in the RAM or the like. Here, it is assumed that 50 mg per page is set as the upper limit value. In the case where the results of the determination indicate that the upper limit value is exceeded, the processing proceeds to step 611. On the other hand, in the case where the total amount of toner to be used is within the upper limit value, the toner saving processing is not necessary for the non-specific object as to the page, and therefore, the processing proceeds to step 615. In the case of the above-described specific example, 50 mg, which is the upper limit value, is exceeded in the page 1 and in the page 2, and therefore, the processing proceeds to step 611. Due to this, the condition of the toner saving processing for the non-specific object is set. Then, for the page 3, the total amount of toner to be used is within the upper limit value, and therefore, the processing proceeds to step 615.

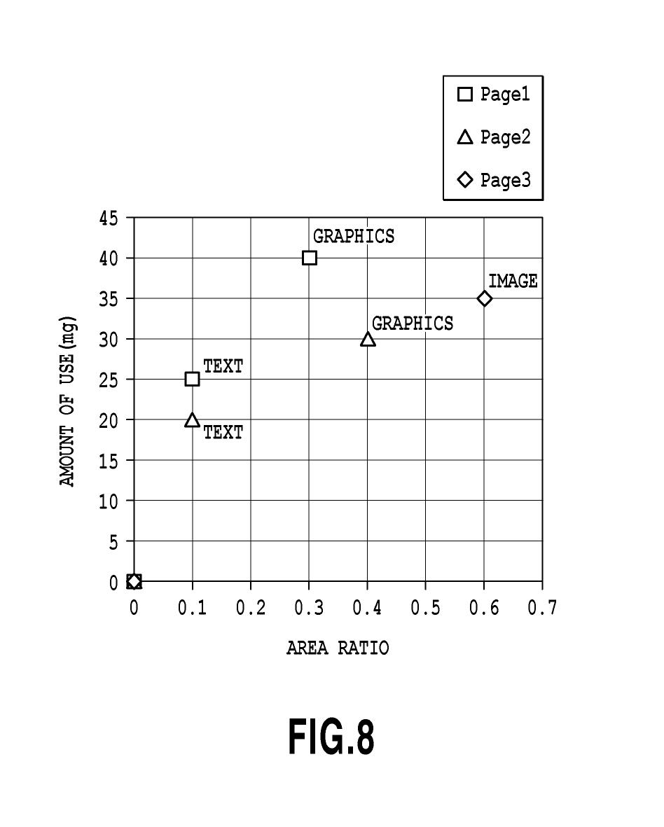

At step 611, the system control unit 202 sets the condition in the toner saving processing method for the non-specific object by taking into consideration the difference between the derived total amount of toner to be used for one page and the upper limit value and the proportion occupied by each object within the page. Specifically, the level of the toner saving processing method (degree in which toner is reduced) is set for each non-specific object in the direction in which the total amount of toner to be used for one page falls within the upper limit value (e.g., in the case of the density decrease processing, the density is decreased). It is possible to set a plurality of levels, for example, such as level 1 (the minimum amount of reduction) to level 5 (the maximum amount of reduction). FIG. 8 is a graph representing the relationship between the derived total amount of toner to be used for each page and the area ratio of the object. In the present embodiment, for the object kind whose distance from the origin is great, the condition with a higher level of reduction effect is set. For example, in the above-described specific example, the total amount of toner to be used for the page 1 is 70 mg, exceeding the upper limit value 50 mg by 40%. Consequently, after taking all the object kinds within the page 1 to be the target for which a level is set, level 2 is set for text, and for graphics whose distance from the origin is great, level 3 at which the reduction effect is greater is set. On the other hand, the total amount of toner to be used for the page 2 is 55 mg, exceeding the upper limit value 50 mg only by 10%. Consequently, only graphics whose distance from the origin is great among the objects within the page 2 are taken to be the target, and level 2 is set. In this manner, the condition of the toner saving processing is set by taking into consideration the degree in which the upper limit value is exceeded and the proportion occupied by the object within the page.

At step 612, the system control unit 202 derives again the total amount of toner to be used necessary to draw one page in the case where the toner saving processing is performed on the non-specific object under the condition set at step 611. In the case where the total amount of toner to be used is derived again, as the amount of toner to be used for the specific object, the value derived at step 608 is used.

At step 613, the system control unit 202 determines again whether or not the total amount of toner to be used for one page derived again is within the predetermined upper limit value. In the case where the results of the determination indicate that the upper limit value is exceeded, the processing returns to step 611 and the condition under which the reduction effect is greater is set again. In this case, for example, on a condition that the level of the object kind whose distance is the greatest from the origin has reached the maximum value, the level of the object kind whose distance from the origin is the second greatest is raised, a new object kind is taken to be the target for which the level is raised, etc. As described above, setting the condition again stepwise (step 611) and deriving again the total amount of toner to be used for one page under the new condition set again (step 612) are repeated. In order to lighten the burden of processing to derive the total amount of toner to be used for one page, for example, it may also be possible to perform the processing on the pixels thinned at fixed periods, to make use of an estimate value by estimating the total amount of toner to be used after the toner saving processing by utilizing the proportions of the object kinds within one page, etc. Due to this, it is possible to reduce the amount of calculation. In the case where the results of the determination indicate that the total amount of toner to be used becomes within the upper limit value, the processing proceeds to step 614.

At step 614, the color material saving processing unit 304 receives instructions from the system control unit 202 and performs the toner saving processing on the non-specific object in accordance with the determined condition in the toner saving processing method in accordance with each attribute.

At step 615, the system control unit 202 determines whether or not the processing has been completed for all the pages. In the case where there is a page on which the processing has not been performed yet, the processing returns to step 609, and the next page is taken to be the page on which the processing is to be performed and the processing is continued. On the other hand, in the case where the processing has been completed for all the pages, the present processing is terminated.

The above is the flow until the toner saving processing is performed on each object within the input image data in the case where the toner saving special processing is set. Although not described explicitly in the present flow, in the case where the total amount of toner to be used does not become within the upper limit value even by raising the level of all the object kinds to the highest level, it is sufficient to perform error processing or the like to notify a user of the fact. The image data for all the pages on which the toner saving processing has been performed is sent to the image processing unit 206 and after predetermined image processing is performed, the image data is provided to the printing unit 207.

The case where the results of the determination processing at step 610 described above are Yes means that the amount of toner to be used is within the upper limit value and it is not necessary to perform the toner saving processing on the non-specific object in the page. Consequently, in the flowchart in FIG. 6B, step 611 to step 614 are skipped. In place of such control, at step 611, it may also be possible to set the condition under which the toner saving processing is not performed substantially (e.g., level 0: Thinning ratio or Density decrease ratio is set to 0%).

In the processing at step 611 in the second or subsequent routine, the condition of the toner saving processing method is changed into a higher level at which the reduction effect is greater, but it may also be possible to configure the flow so as to change the processing method itself. For example, in the case where the non-specific object is a color image, on a condition that the total amount of toner to be used within the page is not within the upper limit value even by setting the new condition to the level 5 (e.g., Density decrease ratio 70%), which is the highest level, the processing method may be changed into another processing method whose reduction effect is greater (e.g., monochromatization processing).

According to the present embodiment, it is made possible to perform printing in which the amount of color material is saved while maintaining the visual recognizability and the sense of uniform of the appearance by imposing certain limitations on the toner saving processing for a specific object, such as a stamp.

### Second Embodiment

In the first embodiment, the mechanism is explained in which the special processing including the processing to prohibit the toner saving processing for a specific object is applied in the case where the processing to reduce the amount of toner to be used so as to be within the upper limit value is performed. Next, an aspect is explained as a second embodiment in which the amount of toner to be used is controlled so as to be suitable to the printing charge contract in multiple stages by applying the mechanism of the first embodiment. Explanation of the portions in common to those of the first embodiment is omitted or simplified and in the following, different points are explained mainly.

In the case of an electrographic MFP, it is frequent that a contract is made with a service company for replenishment of consumables, such as a toner cartridge, and maintenance of the MFP together. There are a variety of contract types and here, explanation is given by taking the printing control in a contract that the use fee is charged in accordance with the duty ratio representing the color material density on printed matter as an example. Here, the duty ratio is defined as a quotient obtained by dividing the total value of the signal value of each of CMYK per page in input image data to be printed by the maximum value (in the case of 8-bit value, 255×4 (colors)×number of pixels). In this case, the signal value of each of CMYK is the value after the so-called gamma correction processing is performed and immediately before the quantization processing is performed, and is substantially in a linear relationship with the amount of toner to be used. Table 3 shown below indicates an example of a contract in which the use fee is charged in accordance with the duty ratio.

TABLE 3

| CONTRACT | UPPER LIMIT OF | |
|---|---|---|
| TYPE | DUTY RATIO | COST |
| S | s % | HIGHER |
| A | a % | [symbol] |
| B | b % | [symbol] |
| C | c % | LOWER |

In the example of Table 3, contracts at four levels, i.e., S, A, B, and C, are provided and at each level, the upper limit value of duty ratio is determined. In this example, the duty ratios are in the relationship of s %>a %>b %>c % and the contract fee is the highest in the case of S contract and the lowest in the case of C contract. At this time, even in the case where an attempt is made to print image data having a very high density with an apparatus under C contract, printing in which the cost is kept low by some methods is performed in the case where c % is exceeded. Specifically, control is performed so that the value obtained by multiplying the duty ratio by a predetermined coefficient is used as the upper limit value of the amount of toner to be used for each of CMYK and printing is available only within the range of the upper limit value. As a method for keeping the cost low, conventionally, there is a toner saving mode. In the toner saving mode, image conversion is carried out in order to decrease the output density of image data, processing to reduce the amount of color material to be attached by changing the control of the printing apparatus, etc., are performed.

For example, under C contract, there is a case where a special object, such as a logo of a company or project, and a symbol mark and a stamp for attracting attention, whose density should be prevented from being decreased extremely, is included in image data. This problem will be solved by specifying and registering these special objects in advance and by handling these objects as the specific object in the first embodiment.

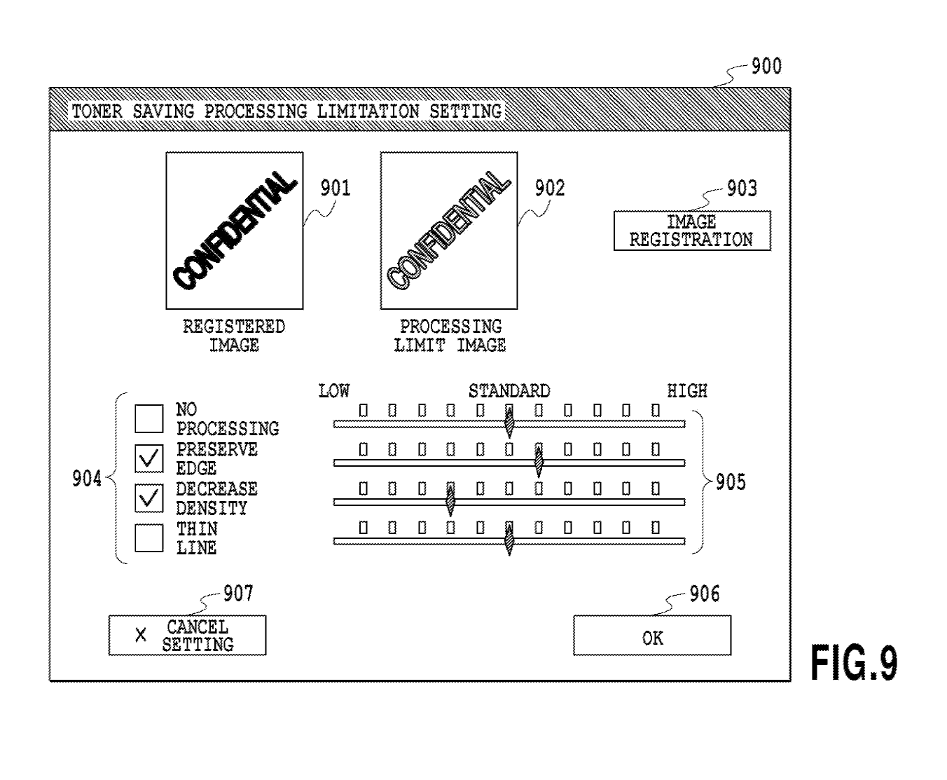

FIG. 9 shows an example of a setting screen for specifying limitations on the toner saving processing for the specific object. On a setting screen 900, in a registered image display area 901, the image of a specific object before the toner saving processing is performed is displayed. In a processing limit image display area 902, the image that would be obtained in the case where the toner saving processing at the highest level that can be permitted for the specific object is performed is displayed. In the case where an Image registration button 903 is pressed down, a screen (not shown) for registering a specific object is displayed and the image specified on the screen is displayed in the registered image display area 901. Checkboxes 904 are used to specify the toner saving processing method, corresponding to the checkboxes 422 in FIG. 4B. A processing level setting area 905 is used to specify the level (intensity) of the processing in each toner saving processing method and it is possible to specify the highest level that can be permitted for the registered image. FIG. 9 shows that the permitted range of the toner saving processing for the registered image is up to the level one step higher than the standard level for the edge preservation processing and up to the level two steps lower than the standard level for the density decrease processing. The image that would be obtained in the case where the toner saving processing is performed at the permitted limit level specified as described above is performed is displayed in the highest level processing image display area 902. The above settings are performed and registered in advance by, for example, an administrator of the apparatus.

Then, in the case where the stage is reached in which the toner saving processing is performed because the duty ratio upper limit value is exceeded, whether or not a registered image (specific object) is included in the input image data is determined by using a publicly known recognition technique (pattern matching or the like). In the case where the results of the determination indicate that a specific object is included, control is performed so that the toner saving processing in accordance with the contents of the setting specified on the above-described setting screen 900 is performed on the specific object.

In this manner, in the case where printing of an image to which a stamp or the like registered in advance is attached is performed, the quality of the stamp or the like is guaranteed even on a condition that the duty ratio upper limit value is exceeded.

In the above-described example, an image, such as a stamp, is registered in advance by an administrator. However, it may also be possible to enable a user to specify a stamp or the like as a specific object in the case where the stage is reached in which the toner saving processing is performed because the duty ratio upper limit value is exceeded by notifying the user of the fact.

According to the present embodiment, even in the case where the toner saving processing is performed independently of the intention of a user at the time of printing, such as under the use contract on the basis of the duty ratio, it is made possible to prevent the image quality from being degraded out of a registered range for a special object whose image quality is desired to be maintained.

### Third Embodiment

Next, an aspect is explained as a third embodiment in which a toner saving processing method that is applied to a specific object is automatically determined from the kind (file format) of input image data to be printed. Explanation of the portions in common to those of the first embodiment is omitted or simplified and in the following, different points are explained mainly.

In the present embodiment, at step 601 in the flowchart in FIG. 6A described previously, in the case where the setting of the toner saving special processing is determined to be the setting such that the processing is performed automatically, a toner saving processing method that is applied to a specific object is determined automatically by referring to, for example, Table 4 as shown below.

Table 4 is an example of a table for automatically determining a toner saving processing method that is applied to a specific object based on the file format of input image data.

TABLE 4
CORRESPONDENCE TABLE OF KINDS OF FILES

| | | TONER SAVING |
|---|---|---|
| TENDENCY | | PROCESSING |
| PREDICTED | EXAMPLE | METHOD FOR |
| FROM KIND OF FILE | (EXTENSION) | SPECIFIC OBJECT |
| TEXT IS INCLUDED | .txt, .doc, .docx, xls, | THINNING |
| MAINLY | xlsx | PROCESSING |
| GRAPHICS ARE | .ppt, .pptx | EDGE PRESERVATION |
| INCLUDED MAINLY | | PROCESSING |
| IMAGES ARE | .jpg | DENSITY DECREASE |
| INCLUDED MAINLY | | PROCESSING |

In Table 4 described above, based on the tendency of each file, an extension for specifying the file format and a toner saving processing method are associated with each other. For example, in a file whose extension is “.txt”, only text is included, and therefore, a toner saving processing method of an object that is more likely to be handled as a specific object, such as a header or footer other than the main text, is set to thinning processing suitable to text.

By determining a toner saving processing method for a specific object by using such a table, a toner saving processing method and an initial value in accordance with the tendency of the object within the file are set as a result. Further, it is possible to save time taken by object analysis processing as well as omitting a troublesome setting a user needs to perform manually.

It may also be possible to configure a table such as Table 4 described above as one whose contents can be rewritten by a user. Further, it may also be possible to configure a table such as Table 4 as one whose contents can be changed temporarily in the actual printing stage.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, in the case where printing is performed while reducing the amount of color material to be used, it is possible to maintain the visual recognizability of objects while maintaining the quality of a specific object common to a plurality of pages.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-173737, filed Aug. 28, 2014, which is hereby incorporated by reference wherein in its entirety.

What is claimed is:

1. An image forming apparatus having a color material saving mode to save an amount of color material to be used at the time of printing input image data, the apparatus comprising,
a user interface for a user to perform an input operation, wherein
the user interface includes:
a unit configured to register an image of a specific object used in the input image data; and
a unit configured to specify an image processing method for reducing an amount of color material to be used, which is applied to the registered image of the specific object at the time of printing the input data in the color material saving mode.

2. The image forming apparatus according to claim 1, wherein
the user interface further includes a unit configured to set a level in the image processing method.

3. The image forming apparatus according to claim 1, wherein
the user interface further includes a unit configured to display the registered image of the specific object.

4. The image forming apparatus according to claim 2, wherein
the user interface further includes a unit configured to display a processing image in a case where the image processing is performed on the image of the specific object registered at the level set by the setting unit.

5. The image forming apparatus according to claim 1, wherein
the image processing is thinning processing to reduce a width of a line for the registered image of the specific object.

6. The image forming apparatus according to claim 1, wherein
the image processing is density decrease processing to decrease an output density by increasing a luminance value for the registered image of the specific object.

7. The image forming apparatus according to claim 1, wherein
the image processing is edge preservation processing to preserve only edge areas and to decrease the density of other areas for the registered image of the specific object.

8. The image forming apparatus according to claim 1, wherein
the image processing is monochromatization processing to convert a color image into a monochrome image for the registered image of the specific object.

9. The image forming apparatus according to claim 1, wherein
the color material is toner or ink.

10. A control method of an image forming apparatus having a color material saving mode to save an amount of color material to be used at the time of printing input image data, wherein
the image forming apparatus includes a user interface for a user to perform an input operation, the control method comprising the steps of:
registering, by using the user interface, an image of a specific object that is used in the input image data; and
specifying, by using the user interface, an image processing method for reducing an amount of color material to be used, which is applied to the registered image of the specific object at the time of printing the input data in the color material saving mode.

11. An image forming apparatus comprising:
a specifying unit configured to specify image processing that is performed on a registered image in a case where a toner saving mode is instructed;
a storage unit configured to store the kind of image processing specified by the specifying unit; and
a processing unit configured to perform the stored kind of image processing on an input image in a case where the color material saving mode is instructed.

12. A non-transitory computer readable storage medium storing a program for causing a computer to perform the following steps of:
registering, by using a user interface, an image of a specific object that is used in input image data; and
specifying, by using the user interface, an image processing method for reducing an amount of color material to be used, which is applied to the registered image of the specific object at the time of printing the input data in a color material saving mode.
